(19) United States
(12) Patent Application Publication
(10) Pub. No.: US 2006/0148556 A1
(43) Pub. Date: Jul. 6, 2006

(54) Electronic game scripting and auditing

(76) Inventor: Scott N. Weller, Salem, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 11/291,109

(22) Filed: Nov. 30, 2005

Related U.S. Application Data
(60) Provisional application No. 60/632,723, filed on Nov. 30, 2004.

(51) Int. Cl. A63F 13/00

(52) U.S. Cl. 463/25; 463/29

(57) ABSTRACT

A system and method is provided for conducting electronic games of chance and methods of and systems for providing scripting of electronic game play. Further, game play by a player may be audited by storing player's actions in a memory of a computer system. A game computer determines an outcome for the game and then scripts the play of the game for the player prior to the beginning of the game play by the player. The outcome for the game may be determined prior to ticket printing, issuance, or purchase or after ticket purchase but before the onset of game play. The game script may be determined at any time after the outcome is determined but before the onset of game play.

### RELATED APPLICATION

This application claims priority under 35 U.S.C. §119(e) to U.S. Provisional Application Ser. No. 60/632,723 entitled “ELECTRONIC GAME SCRIPTING AND AUDITING,” filed on Nov. 30, 2004, which is herein incorporated by reference in its entirety.

### FIELD OF THE INVENTION

The present invention relates to electronic games of chance and methods and systems for conducting game play.

### DESCRIPTION OF THE RELATED ART

Casino card games of skill and chance, including poker and blackjack, have game outcomes that are dependent upon how the player plays and upon how the cards are turned. That is, the outcome of a game is not predetermined. Slot machines are also games of chance that determine the outcome for the game when the reels are spun. The outcome is generally determined randomly by a random number generator (RNG). A player that plays multiple spins has the outcome determined by the slot machine with each spin. The outcome of each spin of a slot machine may be recorded electronically for later review.

Some scratch ticket lottery games have a predetermined outcome, however, how (e.g., the sequence, what scratch areas) the player scratches off a ticket is not predetermined. For example, certain types of scratch tickets may have more than one possible outcome, and the end result may depend upon the order that the player scratches off the spots on the ticket.

Electronic games of skill do not have a predetermined outcome by definition, and thus the electronic play of the game is not known apriori as the player, by his/her skill influences the outcome of the game. Electronic lottery games may have a predetermined possible outcome, but the outcome for a player is still dependent upon how the player plays the electronic lottery, which is not predetermined.

There is a present and recurring need for new electronic games of chance. Such a game is needed to attract new game players and to provide existing players game of chance.

### SUMMARY OF THE INVENTION

According to one aspect of the present invention, a computer-based game is provided. The computer-based game comprises a payment component that permits a player to pay to play a game of chance, a game computer predetermining an outcome for the game, a game computer predetermining a script to obtain the predetermined outcome for the game, and a component that permits the player to play the game. According to one embodiment of the present invention, the predetermined outcome is a losing outcome. According to another embodiment, the predetermined outcome is a winning outcome. According to another embodiment, the predetermined script has the winning outcome being revealed in one or more payouts that are in total the winning outcome. According to another embodiment, the predetermined script includes information that describes an order of game displays that are revealed to the player. According to another embodiment, the predetermined script is played out independent of input by the player.

According to one embodiment of the present invention, content displayed to the player in the game is adjusted to match the predetermined script and input by the player. According to another embodiment, an order of the content displayed to the player is recorded. According to another embodiment, an order of the player input is recorded. According to another embodiment, the player pays to play with at least one of money and loyalty points. According to another embodiment, the player pays by at least one of cash, a debit card, a credit card, an account credit, and a loyalty program credit. According to another embodiment, the player is permitted to subscribe to play multiple game sessions. According to another embodiment, the player is permitted to automatically renew the subscription. According to another embodiment, a player plays the electronic game of chance on at least one of a television, a personal computer, a kiosk, a handheld device, a telephone having a display, and in person. According to another embodiment, the payout for winning may include at least one of money, a credit, merchandise, and loyalty points.

According to one embodiment of the present invention, the payout for winning money is performed by providing at least one of cash, a check, a debit card, and an account credit. According to another embodiment, the payout for winning loyalty points is performed by providing at least one of a loyalty program credit and an account credit. According to another embodiment, the game sessions are run continually. According to another embodiment, the winning outcome is chosen in a random manner. According to another embodiment, the player tells the gaming operator or computer system that the player has won. According to another embodiment, the player and the winning outcome must be verified and authenticated by the gaming operator. According to another embodiment, a game playing computer system displays to all players when there is a winner. According to another embodiment, a game playing computer system displays to all players at least one of the winning game card and the winning player.

According to one embodiment of the present invention, the game sessions are run continually, and wherein advertising streams are inserted into the display during the game session. According to another embodiment, the game sessions are run continually, and wherein advertising streams displayed between individual game sessions. According to another embodiment, the player may enter a game session through an alternative method of entry (AMOE). According to another embodiment, the game and its associated game session are played using one or more computer systems. According to another embodiment, the predetermined outcome is determined prior to the beginning of game play by the player. According to another embodiment, the predetermined outcome is determined prior to at least one of the player paying for the game and subscribing to the game. According to another embodiment, the predetermined outcome is determined after the player performs at least one of paying for the game and subscribing to the game.

According to one embodiment of the present invention, the predetermined script is determined prior to the beginning of game play by the player. According to another embodiment, the game script includes one or more elements of the game. According to another embodiment of the present invention, the game script includes a pay table. According to another embodiment, the pay table lists possible combinations for obtaining a specific total payout amount listed in a row of the pay table. According to another embodiment, the game script includes at least one of audit type, security code(s), number drawing order, prize reveal order, prize placement, game display, and total game payout.

Further features and advantages of the present invention as well as the structure and operation of various embodiments of the present invention are described in detail below with reference to the accompanying drawings. In the drawings, like reference numerals indicate like or functionally similar elements.

### BRIEF DESCRIPTION OF THE DRAWINGS

In the drawings,

FIG. 1 is a flow chart of a process for scripting electronic game play according to one embodiment of the present invention;

FIG. 2 is a flow chart of a process for auditing electronic game play according to one embodiment of the present invention;

FIG. 3 shows components of a game computer system according to one embodiment of the present invention;

FIG. 4 shows components of a game payment subsystem according to one embodiment of the present invention;

FIG. 5 shows components of a game payout subsystem according to one embodiment of the present invention;

FIG. 6 shows components of a game playing and viewing subsystem according to one embodiment of the present invention;

FIG. 7 is block diagram of a general-purpose computer system upon which various aspects of the present invention may be implemented; and

FIG. 8 is a computer data storage system that may be used in conjunction with various aspects of the present invention.

### DETAILED DESCRIPTION OF THE INVENTION

According to one aspect of the invention, an electronic game of chance is provided that has a predetermined outcome. Further, with such outcome is provided a predetermined “script” that determines how the predetermined outcome will be provided to the game player. Existing games of chance engineer a prize structure to distribute winnings, but do not determine the game experience that a player receives while playing the game. By predetermining the game play script, according to one aspect or the present invention, a game designer or automated process can also engineer the “fun factor” into the game.

According to one embodiment of the present invention, a presentation of a winning outcome for the electronic game of chance may be awarded to a player through one or more payouts. These payouts may be engineered to provide a scripted series of payouts presented to the player while the player plays the electronic game of chance. According to one aspect, it is appreciated that multiple payouts for obtaining a winning outcome provide a player a greater fun factor and more exciting game play. According to another embodiment, a losing outcome for the electronic game of chance may be engineered to seem to be close to winning to provide some excitement and suspense to the player. In general, a scripting of an electronic game of chance may be performed that provides a more exciting, suspenseful, and fun playing experience for the player. As a result, the player may be motivated to play more games.

According to another embodiment, the game script may comprise the exact steps and displays that a player may be shown. In one example, the order of the steps in the game script may be important and explicit to determine the proper game playing experience for the player. Of course, it should be appreciated that not all portions or outcomes related to the experience need to be scripted, and the invention is not limited to scripting all outcomes or experiences. For instance, a portion of the outcomes may be scripted while another portion may be determined in another manner (e.g., randomly, through formulas or rules, etc.).

According to another embodiment of the invention, numerous aspects of the playing experience are scripted. In one example, most or all of the playing experience is scripted. For example, in an online lottery game having a scratch-off ticket, the look of the ticket, the look and position of scratch-off spots, the location of hidden items or the order in which hidden items are revealed (independent of what scratch-off spot is scratched), whether a ticket wins or loses, and what a ticket pays may be among the items that may be scripted (e.g., by a game designer). Any online game may be scripted in such a manner to describe a game element, including those elements used for display or play. Such online games and their associated scripted elements may include, for example, card games (e.g., the look of the deck, the order of the cards, how the cards are dealt, etc.), bingo (e.g., the bingo card layout, the winning pattern, the look of the bingo ball, etc.), and other types of games and their elements that can reveal a scripted outcome.

According to another embodiment of the invention, a pay table associated with the game of chance may be scripted. In one example, how a particular payout in the pay table may be performed may be scripted. In particular for a particular entry in the pay table, there may be one or more associated “scripts” that determine how the outcome is achieved (and thus revealed to the player). Scripts for each of the pay table elements may be distributed to the game operator in a table that lists all the various combinations possible for winning each particular payout amount. For instance, the possible scripted outcomes for each pay table entry may be listed in one line of the pay table. For example, a standard pay table may appear similar to the following table I which lists, in one example, every possible prize combination with its corresponding total prize value.

TABLE I
Example Prize Table

| PRIZE | PRIZE VALUE |
|---|---|
| 1,000,000 + SPORTS CAR | 1,098,000 |
| 1,098,000 | 1,098,000 |
| 800,000 + 200,000 | 1,000,000 |
| 500,000 + 500,000 | 1,000,000 |
| 500,000 | 500,000 |
| 250,000 + 250,000 | 500,000 |
| 100,000 + 50,000 | 150,000 |
| 50,000 | 50,000 |
| 10,000 + 20,000 | 30,000 |
| 1,000 + 1,000 + 3,000 | 5,000 |
| 100 | 100 |
| 50 + 50 | 100 |
| 25 + 25 + 25 + 25 | 100 |
| 20 + 20 + 20 + 20 + 20 | 100 |
| 15 + 5 + 5 + 25 + 50 | 100 |
| 5 + 5 | 10 |
| 1 + 1 + 1 + 1 + 1 + 5 | 10 |

However, according to one aspect of the present invention, the pay table may be distributed as the following table II or similar form which summarizes all the possible prize combinations for each total prize amount.

TABLE II
Example Prize Distribution

| PRIZE | TOTAL | PRIZE COMBINATIONS |
|---|---|---|
| 1,098,000 | 2 | (1,098,000), (1,000,000 + SPORTS CAR) |
| 1,000,000 | 2 | (800,000 + 200,000), (500,000 + 500,000) |
| 500,000 | 2 | (500,000 + 500,000), (250,000 + 250,000) |
| 150,000 | 1 | (100,000 + 50,000) |
| 50,000 | 1 | (50,000) |
| 30,000 | 1 | (10,000 + 20,000) |
| 5,000 | 1 | (1,000 + 1,000 + 3,000) |
| 100 | 5 | (100), (50 + 50), (25 + 25 + 25 + 25), |
| | | (20 + 20 + 20 + 20 + 20), |
| | | (15 + 5 + 5 + 25 + 50) |
| 10 | 2 | (5 + 5), (1 + 1 + 1 + 1 + 1 + 5) |

According to another embodiment of the present invention, security may be used in association with game script information to permit authentication of a particular game script. For instance, industry standard security measures (e.g., a checksum) may be encoded into the game script. Such security measures may be decoded prior to play or redemption of game winning. This may allow, for example, a game operator to confirm the authenticity of the game script prior to play of the game, or to permit a particular game scripted game to be verified prior to payment.

According to another aspect of the invention, the play of the electronic game of chance is auditable. For instance, an electronic game of chance may be provided wherein content (e.g., electronic content in the form of displays) displayed to a player may be recorded.

Further, the player's responses to such display of content may also be recorded. Auditing of the electronic game of chance may permit, for example, determination whether the script was followed in the game. Game auditing may record other aspects of game play such as, for example, whether and/or when a game was paused, stopped, or cut off so that a player may resume play at a later time without replaying any moves. Such audit information may be recorded in a memory of a game playing system.

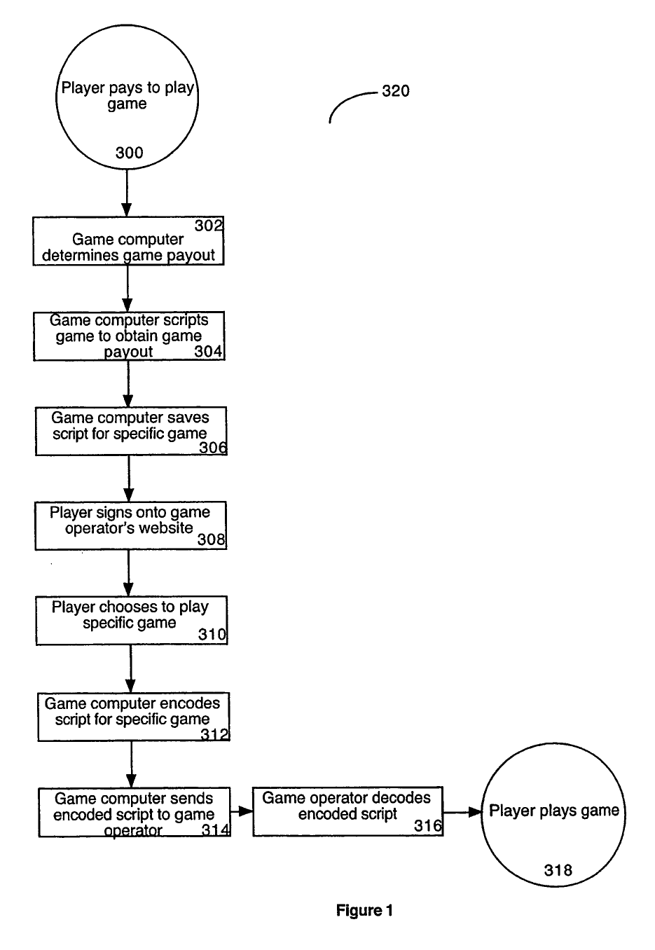

FIG. 1 shows an example process for scripting an electronic game of chance according to one embodiment of the invention. Process 320 may begin with a player paying or subscribing to play a game at block 300. A player may pay to play using any known method including by telephone, the Internet, cashier (e.g., at a casino or lottery agent) and/or pay-per-view using any known payment type including cash, credit card, debit card and/or loyalty account. Although process 320 shows a scripting method for playing an electronic game of chance, it should be appreciated that similar methods may be used for scripting games according to various aspects of the invention and that the invention is not limited to any particular content.

In one embodiment of the invention, players may subscribe to play multiple game sessions. That is, one or more players pay to play more than one game session. A player may pay at one time to play many consecutive games (e.g., by purchasing a subscription to consecutively-played games). According to one embodiment, such players may subscribe to multiple games using a computer-based interface (e.g., a personal computer, cell phone, PDA, set top box, or other interface). These subscribed games may be automatically played (for instance, by a computer system). In another embodiment, a player may choose to have his or her subscription automatically renewed.

According to another embodiment of the invention, the player may also enter to play the game of chance using an alternative method of entry (AMOE). AMOE is a required available method of entry that does not require a purchase to enter a sweepstake. As is known, sweepstakes are usually used as a promotional or marketing tool. An individual entering a sweepstakes by AMOE is required by law to have the same odds of winning each of the available prizes.

A common AMOE method includes requiring an individual interested in entering the sweepstakes send in a postcard with his or her name, address or other contact information. Another AMOE method includes requiring an individual to sign on to a free Internet website and to submit the required information for free. Numerous other methods may be used for AMOE. Most sweepstakes limit the number of times one individual or family may enter a sweepstake by AMOE.

According to one embodiment of the present invention, it is realized that an AMOE (alternative method of entry) may be used to enter a game of skill or chance. More particularly, it is possible to develop, implement and run wagering games of skill or chance, including the inventive games described herein, with an AMOE method of entry. AMOE methods are conventionally used to enter a player in a sweepstakes, which is not considered wagering or gambling. Thus, according to one embodiment of the invention, an individual may enter the a wagering game of skill or chance by AMOE using, for example, the postcard or the online method outlined above. The wagering game of skill or chance player entering by AMOE may also have the same odds to win the payout associated with the game in which they are entered. The wagering game of skill or chance player entering by AMOE may also be limited to a small number of games game sessions within a given period of time; for example a player entering by AMOE may be limited to entering one game session in one year or two games game sessions in one month. Other numbers of games and given periods may be any number, and the invention is not limited to any particular implementation.

Once the player pays or enters to play a game, the game computer may determine a game payout or outcome for the game at block 302. The game computer may determine the outcome, for example, when the player pays for the first game or all games for which the player purchased a subscription. Alternatively, the game computer may determine the outcome for the first game or all games the player paid for when the player signs onto the game operator's website to play the game.

It should be understood that the game computer may determine a game outcome at any time prior to the beginning of game play, and the game script may be determined, for example, between the two events. The game outcome may be determined prior to game ticket printing, prior to game ticket issuance to a reseller (e.g., casino, lottery agent, or bingo hall), prior to ticket purchase, or after the ticket purchase but before the beginning of game play.

For game outcomes determined after a ticket purchase, the outcome may be tied to a specific event or game session still to be held (e.g., a keno or bingo drawing held the following Friday at 3:00 PM). In such a case, outcomes may be related to numbers selected for the player, and the outcome is determined based upon a matching between the player's selected numbers and the numbers drawn at the predetermined time. In such an instance, the game ticket may also have a delayed activation to prevent a game player from trying to play the game prior to the determination of the game outcome and the game script.

As used herein, a “user interface” or “UI” is an interface between a human user and a computer that enables communication between a user and a computer. Types of UIs that may be used to play the game of chance include a graphical user interfaces (GUI), a display screen, a mouse, a keyboard, a keypad, a trackball, a microphone (e.g., to be used in conjunction with a voice recognition system), a speaker, a touch screen, a telephone, a game controller (e.g., a joystick) etc, and any combinations thereof.

At block 304, the game computer may determine the game script and at block 306, the computer saves the script. The script may be determined, for example, soon after the payout is determined but may be determined up until the time the player enters the game operator's website. According to one embodiment, the game script may include information that describes how the payout will be made to the game player (e.g., a $100 payout may be paid out as a $100 payment, two $50 payments, five $20 payments, one $40 and two $30 payments, or any other combination to make a $100 total).

The payout for winning may include, for example, money, a credit, merchandise (e.g., a car or vacation), additional game play, and/or loyalty points or any combination thereof. According to another embodiment of the present invention, the payout for winning money is performed by providing a player cash, a check, a debit card, and/or an account credit. According to another embodiment, the payout for winning loyalty points is performed by providing to the player a loyalty program credit and/or an account credit.

At block 308, a player signs onto a game operator's website through a user interface and chooses to play a specific game at block 310. In one example, the game computer then encodes the script for the game selected by the player at step 312. The game computer sends the encoded script to the game operator at block 314. In one example, the game operator may have a computer-based system that is adapted to decode the game script and determine game play based on the decoded game script. The game operator then decodes the game script at block 316 and displays the game and runs the script as the player plays the game at block 318.

It should be appreciated that the game may be played by one or more computer systems (e.g., a game operator computer system, a player's computer system, etc.) and one or more operations may be performed by any computer system or portion thereof. For instance, a computer controlled by the game operator may decode the script, and a player's computer may be used to display the game to the player.

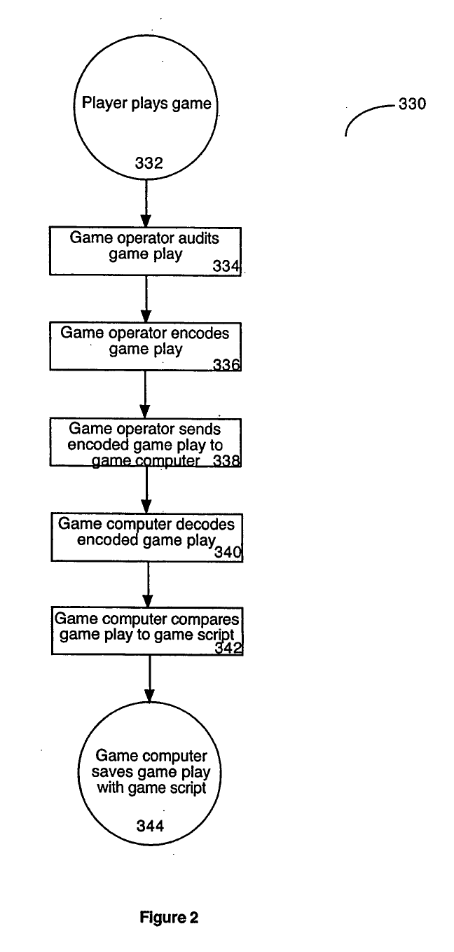

FIG. 2 shows an example process 330 for auditing an electronic game of chance according to one embodiment of the invention. As the player plays the game at block 332 (or FIG. 1 block 318), the game operator audits the game play at block 334. For example, the game operator may record the order of screens displayed to the player or any other displayed information or game status information relating to game play. Further, the game operator may record the player's responses, actions, and/or choices during the game. Further, the game operator may also record other game information, such as, for example, progress information in the game, if a game session was interrupted, when the session was stopped, etc.

At block 336, the game operator encodes the game play and sends the encoded game play to the game computer at block 338. A game computer then decodes the game play at block 340 and compares the game play to the game script at block 342. The game computer then saves the game play with the game script at block 344.

A data stream may be transmitted without encoding and decoding between the game operator and the game computer. That is, information may be transmitted over a network without some sort of encryption or other security method being used. Transmission of data without any further security may be an acceptable security risk when the game operator and game computer are run by the same entity in the same location. However, encoding and decoding of the data stream may be desirable for added security.

Process 330 is an example of a game auditing process that may be performed after a game script is played. However, game auditing may also occur during the play of a game. For example, a game operator may send the audit information following each action of a game to a game computer in much the manner a complete game audit file may be submitted above.

As another example, a game operator may determine the next element or display to be shown during game play and send a confirmation request to a game computer prior to displaying the next element or display. A game computer may then confirm or not confirm the next element or display (e.g., as determined by the game operator) from the game script is correct and able to be displayed. A game computer may keep a record of the confirmation requests from the game operator as a stored audit trail.

As another embodiment of the invention, the type of audit to be performed by the game operator is encoded in the game script.

Processes 320 and 330 are merely example methods for performing scripting and auditing of electronic games of chance according to certain embodiments of the invention. Such illustrative embodiments are not intended to limit the scope of the invention, as any of numerous other implementations of scripting and auditing electronic games of chance, for example, variations of game scripting, are possible and are intended to fall within the scope of the invention. For example, the game computer and game operator may be the same entity. None of the claims set forth below are intended to be limited to any particular implementation of electronic game of chance scripting and auditing unless such claim includes a limitation explicitly reciting a particular implementation.

Processes 320 and 330 may include additional acts. Further, the order of the acts performed as part of processes 320 and 330 are not limited to the order illustrated in FIGS. 1 and 2, as the acts may be performed in other orders, and one or more of the acts of processes 320 and 330 may be performed in series or in parallel to one or more other acts, or parts thereof. For example, acts performed at blocks 302 and 308, or parts thereof, may be performed in parallel, acts performed at block 302 may be performed at any point prior to acts performed at block 304, and acts performed at blocks 304 and 306 may be performed serially between acts performed at blocks 310 and 312 in the performance of process 320.

Processes 320 and 330 are merely illustrative embodiments of scripting and auditing for electronic games of chance. Such an illustrative embodiment is not intended to limit the scope of the invention, as any of numerous other implementations of electronic game of chance scripting and auditing, for example, variations of processes 320 and 330, are possible and are intended to fall within the scope of the invention. For example, process 320 may be used for scripting information, story, or other data/content delivery on the Internet or other networks. None of the claims set forth below are intended to be limited to any particular implementation of scripting and auditing electronic content delivery unless such claim includes a limitation explicitly reciting a particular implementation.

Processes 320 and 330, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. Such signals may define instructions, for example, as part of one or more programs that as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of system 100 described below, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

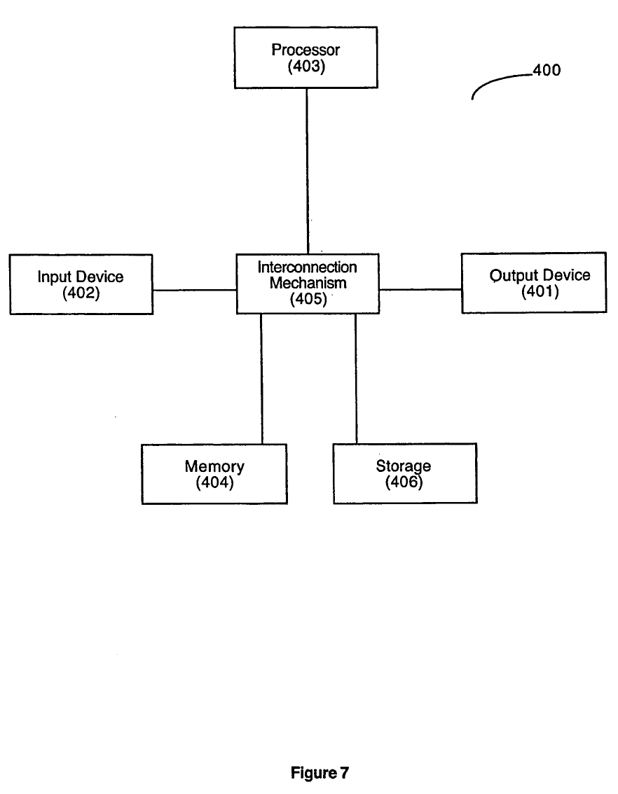

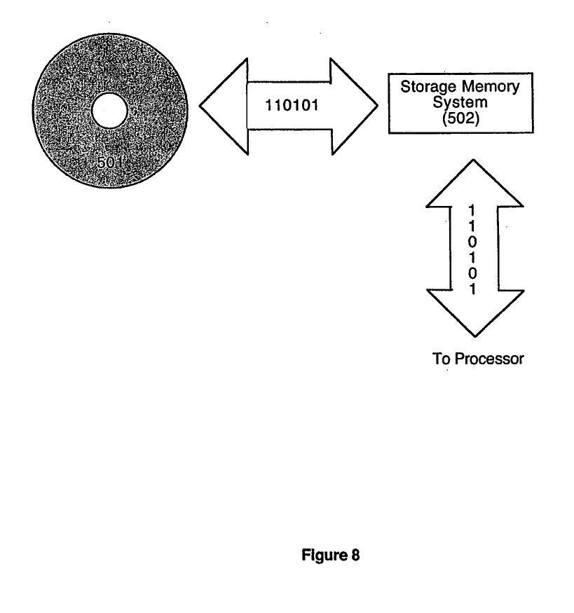

It should be appreciated that any single component or collection of multiple components of a computer system, for example, the computer system described below in relation to FIGS. 7 and 8, that perform the functions described above with respect to describe or reference the method can be generically considered as one or more controllers that control the above-discussed functions. The one or more controllers can be implemented in numerous ways, such as with dedicated hardware, or using a processor that is programmed using microcode or software to perform the functions recited above.

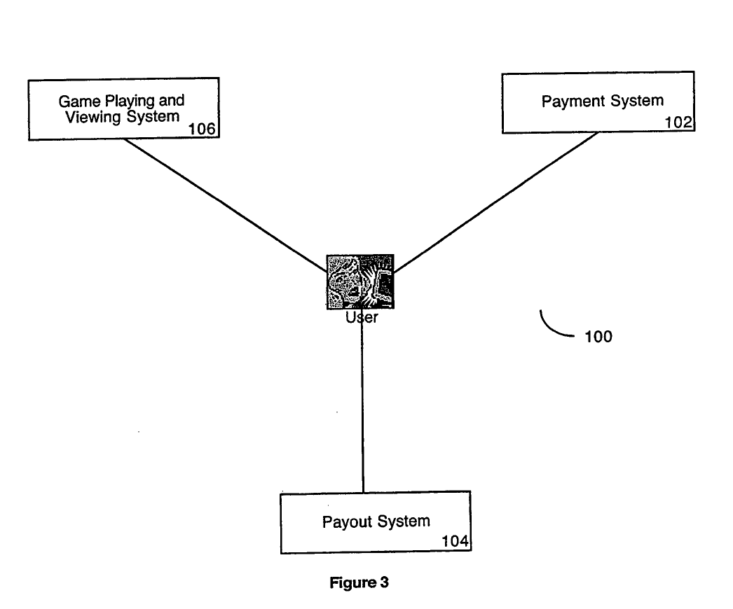

A computer system used to run the example games described above may include one or more component systems (e.g., system 100 as shown in FIG. 3). In one example configuration, one system may handle payment, subscription and/or AMOE by players to enter the game. Another system may handle playing and viewing the game and the third system may handle payouts. The game system may also be connected by direct line or network to other computer systems including systems for handling casino or hotel loyalty programs, reservations, in-room television viewing, or gambling floor kiosks. Connections to other computer systems may be performed using one or more of the system components described below.

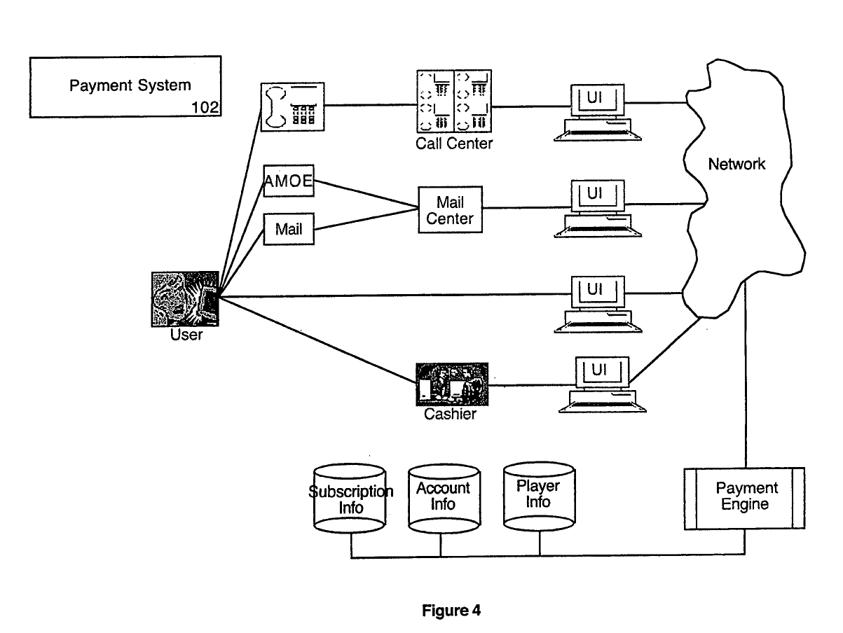

A payment component (e.g., system 102) may include one or more of a number of well-known systems (e.g., as shown in FIG. 4). For example, a player may be able to pay to play one or more games using a telephone and speaking with a call center representative who manually inputs player, payment, and subscription information into a computer using a user interface.

A player may also pay to play using a cashier at a casino that also can enter the above information into a computer system. In the computer system, data may manually be stored in a data structure that is stored in a memory of the computer system. As used herein, a “data structure” is an arrangement of data defined by computer-readable signals. These signals may be read by a computer system, stored on a medium associated with a computer system (e.g., in a memory, on a disk, etc.) and may be transmitted to one or more other computer systems over a communications medium such as, for example, a network. Also as used herein, a “user interface” or “UI” is an interface between a human user and a computer that enables communication between a user and a computer. Types of UIs include a graphical user interface (GUI), a display screen, a mouse, a keyboard, a keypad, a track ball, a microphone (e.g., to be used in conjunction with a voice recognition system), a speaker, a touch screen, a game controller (e.g., a joystick), etc., and any combinations thereof.

Player information may also be entered into a payment system component. Player information that may be input includes name, address, telephone number, and age. Payment information associated with the player may include a credit or debit card number or loyalty account information. Subscription information for games to which the player subscribes may include first game date and time, number of games to play, and bet per game. Based upon the payment and subscription information, the call center representative may then verify that the payment information is valid and that enough credit or funds is available for the player's desired subscription.

A similar system may exist for players entering using the mail or a post card AMOE except the call center may be replaced by a mail center having representatives that enter information into one or more computers via a user interface. For example, a cashier that works at a casino directly with players that pay cash or credit to play, may also have the ability to input player, account, and subscription information using a user interface of a computer system.

Computer systems or pay engines for handling electronic or online payment and subscriptions may also be used. Such systems are well-known, and include such systems as Pay Pal, iKobo, Verisign, and other systems. Using such a system, a player interacts directly with a user interface to input information into a payment data structure that may be transferred to one or more payment systems (e.g., PayPal).

Various pay systems and one or more user interfaces may be located on one or more computer systems coupled by a network with the computer system(s) containing the player, account, and subscription database(s). As used herein, a “network” or a “communications network” is a group of two or more devices interconnected by one or more segments of transmission media on which communications may be exchanged between the devices.

The above are merely an illustrative embodiment of a pay system component. It should be appreciated that such an illustrative embodiment is not intended to limit the scope of the invention, as any of numerous other implementations of a pay system component, for example, variations of online payment, are possible and are intended to fall within the scope of the invention. For example, the payment system component may include using pay-per-view systems associated with interactive television or the pay engine may additionally deliver a receipt to the player by either e-mail or mail. None of the claims set forth below are intended to be limited to any particular implementation of the pay system unless such claim includes a limitation explicitly reciting a particular implementation.

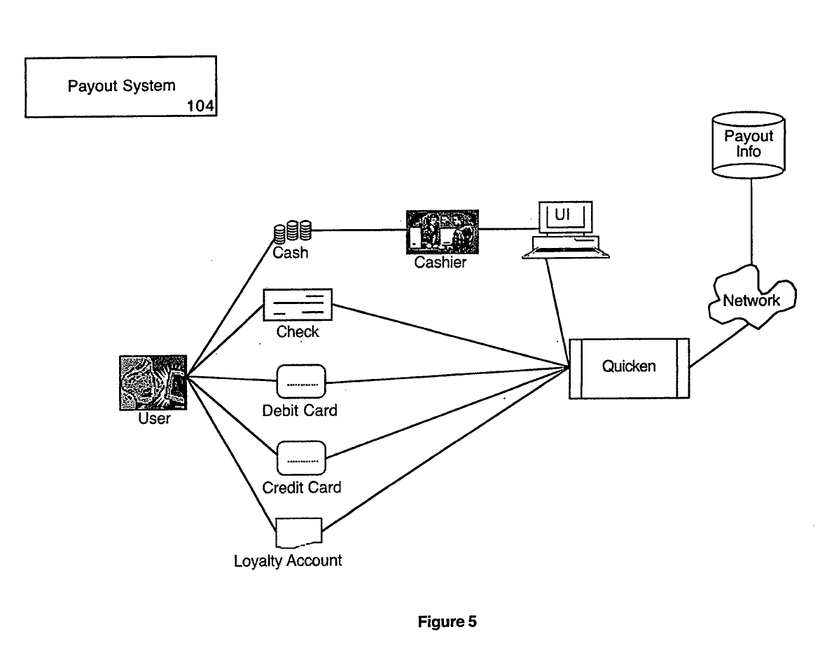

A payout system (element 104) shown in FIG. 5 may be used to perform payouts to players. Any of a number of standard systems or payout engines for making payouts for winning may be used. For example, a standard application programming interface such as ‘Quicken’ (available commercially from Intuit Inc., Mountain View, Calif., USA) may be used to write and mail checks or credit a debit card, credit card (if legal in the jurisdiction of play), or loyalty account. ‘Quicken’ may obtain the payout information by accessing a payout data structure across a network. As used herein, an “application programming interface” or “API” is a set of one or more computer-readable instructions that provide access to one or more other sets of computer-readable instructions that define functions, so that such functions can be configured to be executed on a computer in conjunction with an application program. ‘Quicken’ is merely an illustrative embodiment of the payout system. Such an illustrative embodiment is not intended to limit the scope of the invention, as any of numerous other implementations of the payout system, for example, variations of online payout, are possible and are intended to fall within the scope of the invention. Additionally, a cashier (e.g. at a casino) may also have access to payout information using a user interface to the payout data structure through a network; the cashier then makes a payment to the winning player based upon the accessed information. None of the claims set forth below are intended to be limited to any particular implementation of the pay system unless such claim includes a limitation explicitly reciting a particular implementation.

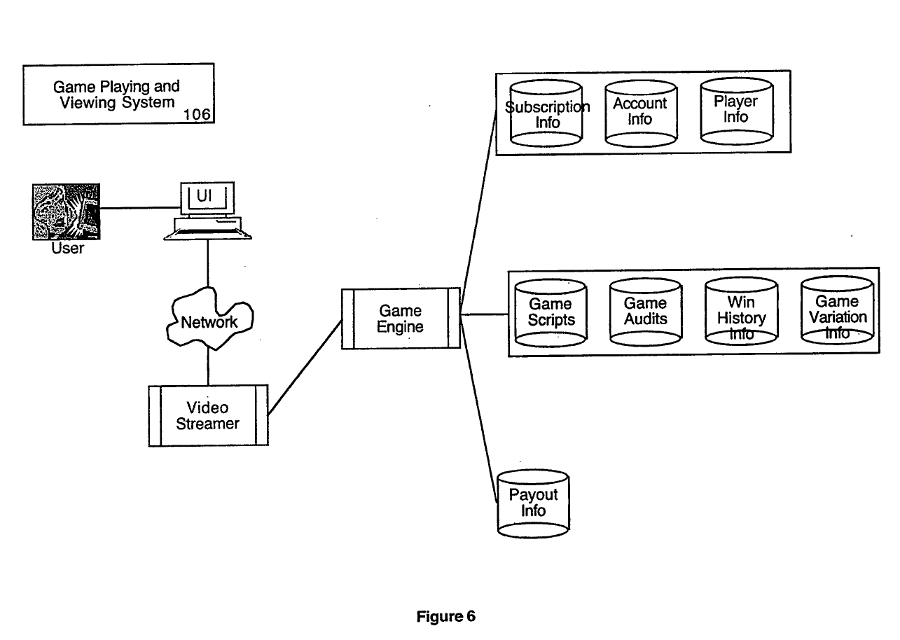

A game playing and viewing system (e.g., system 106) according to one embodiment of the present invention may comprise of a number of components for performing specific functions as shown in FIG. 6. These components may include, for example, storage components that store data structures having information relating to storing game variations, present game session information, game script information, game audit information, game session history, and win history. A game playing and viewing system may also include components used to access payment and payout data structures.

A game playing and viewing system according to one embodiment may also include a game engine. A game engine may perform one or more functions relating to conducting a game of an electronic game of chance. In one example, a game engine may perform functions associated with processes 320 and 330 as shown in FIGS. 1 and 2.

Another component of the viewing system may include a software component (e.g., a driver) that streams video via a network, such as broadband, satellite or wireless medium, to a set top box that controls television viewing. The video driver may read the electronic content, including software and authorization codes, generated by the data engine and convert the content into a video data stream. For interactive television, the video data stream may then be sent by network through national and/or local multi-service operators that distribute the data stream to the individual set top boxes.

The video streamer may also maintain the basic program in its own memory and constantly send the program in a video data stream and insert electronic content, including authorization codes and specific game information of a game system, from the data engine as needed.

The above is merely an illustrative embodiment of a viewing system. Such an illustrative embodiment is not intended to limit the scope of the invention, as any of numerous other implementations of a viewing system, for example, variations of viewing medium, are possible and are intended to fall within the scope of the invention. None of the claims set forth below are intended to be limited to any particular implementation of a viewing system unless such claim includes a limitation explicitly reciting a particular implementation.

System 100, and components thereof such as the payment and data engines, may be implemented using software (e.g., C, C#, C++, Java, or a combination thereof), hardware (e.g., one or more application-specific integrated circuits, processors or other hardware), firmware (e.g., electrically-programmed memory) or any combination thereof. One or more of the components of 100 may reside on a single system (e.g., the payment subsystem), or one or more components may reside on separate, discrete systems. Further, each component may be distributed across multiple systems, and one or more of the systems may be interconnected.

Further, on each of the one or more systems that include one or more components of 100, each of the components may reside in one or more locations on the system. For example, different portions of the components of 100 may reside in different areas of memory (e.g., RAM, ROM, disk, etc.) on the system. Each of such one or more systems may include, among other components, a plurality of known components such as one or more processors, a memory system, a disk storage system, one or more network interfaces, and one or more busses or other internal communication links interconnecting the various components.

System 100 may be implemented on a computer system described below in relation to FIGS. 7 and 8.

System 100 is merely an illustrative embodiment of an electronic gaming system. Such an illustrative embodiment is not intended to limit the scope of the invention, as any of numerous other implementations of an electronic gaming system, for example, variations of 100, are possible and are intended to fall within the scope of the invention. For example, a parallel system for viewing by interactive television may include one or more additional video streamers specific for interactive television. None of the claims set forth below are intended to be limited to any particular implementation of the game system unless such claim includes a limitation explicitly reciting a particular implementation.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to partially or fully automate play of the described game according to various embodiments of the invention. Further, the software design system may be located on a single computer or may be distributed among a plurality of computers attached by a communications network.

A general-purpose computer system according to one embodiment of the invention is configured to perform any of the described conditional access functions including but not limited to player subscription or payment, authorization code generation, electronic content generation and video transmission. It should be appreciated that the system may perform other functions, including network communication, and the invention is not limited to having any particular function or set of functions.

For example, various aspects of the invention may be implemented as specialized software executing in a general-purpose computer system 400 such as that shown in FIG. 7. The computer system 400 may include a processor 403 connected to one or more memory devices 404, such as a disk drive, memory, or other device for storing data. Memory 404 is typically used for storing programs and data during operation of the computer system 400. Components of computer system 400 may be coupled by an interconnection mechanism 405, which may include one or more busses (e.g., between components that are integrated within a same machine) and/or a network (e.g., between components that reside on separate discrete machines). The interconnection mechanism 405 enables communications (e.g., data, instructions) to be exchanged between system components of system 400. Computer system 400 also includes one or more input devices 402, for example, a keyboard, mouse, trackball, microphone, touch screen, and one or more output devices 401, for example, a printing device, display screen, or speaker. In addition, computer system 400 may contain one or more interfaces (not shown) that connect computer system 400 to a communication network (in addition or as an alternative to the interconnection mechanism 405.

The storage system 406, shown in greater detail in FIG. 8, typically includes a computer readable and writeable nonvolatile recording medium 501 in which signals are stored that define a program to be executed by the processor or information stored on or in the medium 501 to be processed by the program. The medium may, for example, be a disk or flash memory. Typically, in operation, the processor causes data to be read from the nonvolatile recording medium 501 into another memory 502 that allows for faster access to the information by the processor than does the medium 501. This memory 502 is typically a volatile, random access memory such as a dynamic random access memory (DRAM) or static memory (SRAM). It may be located in storage system 406, as shown, or in memory system 404, not shown. The processor 403 generally manipulates the data within the integrated circuit memory 404, 502 and then copies the data to the medium 501 after processing is completed. A variety of mechanisms are known for managing data movement between the medium 501 and the integrated circuit memory element 404, 502, and the invention is not limited thereto. The invention is not limited to a particular memory system 404 or storage system 406.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 400 is shown by way of example as one type of computer system upon which various aspects of the invention may be practiced, it should be appreciated that aspects of the invention are not limited to being implemented on the computer system as shown in FIG. 7. Various aspects of the invention may be practiced on one or more computers having a different architecture or components that that shown in FIG. 7.

Computer system 400 may be a general-purpose computer system that is programmable using a high-level computer programming language. Computer system 400 may be also implemented using specially programmed, special purpose hardware. In computer system 400, processor 403 is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME) or Windows XP operating systems available from the Microsoft Corporation, MAC OS System X available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known now or later developed, for performing the recited function.

As used herein, whether in the written description or the claims, the terms “comprising”, “including”, “containing”, “characterized by” and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A computer-based game comprising:
a payment component that permits a player to pay to play a game of chance;
a game computer predetermining an outcome for the game;
a game computer predetermining a script to obtain the predetermined outcome for the game; and
a component that permits the player to play the game.

2. The game according to claim 1, wherein the predetermined outcome is a losing outcome.

3. The game according to claim 1, wherein the predetermined outcome is a winning outcome.

4. The game according to claim 3, wherein the predetermined script has the winning outcome being revealed in one or more payouts that are in total the winning outcome.

5. The game according to claim 1, wherein the predetermined script includes information that describes an order of game displays that are revealed to the player.

6. The game according to claim 1, wherein the predetermined script is played out independent of input by the player.

7. The game according to claim 1, wherein content displayed to the player in the game is adjusted to match the predetermined script and input by the player.

8. The game according to claim 7, wherein an order of the content displayed to the player is recorded.

9. The game according to claim 7, wherein an order of the player input is recorded.

10. The game according to claim 1, wherein the player pays to play with at least one of money and loyalty points.

11. The game according to claim 10, wherein the player pays by at least one of cash, a debit card, a credit card, an account credit, and a loyalty program credit.

12. The game according to claim 1, wherein the player is permitted to subscribe to play multiple game sessions.

13. The game according to claim 12, wherein the player is permitted to automatically renew the subscription.

14. The game according to claim 1, wherein a player plays the electronic game of chance on at least one of a television, a personal computer, a kiosk, a handheld device, a telephone having a display, and in person.

15. The game according to claim 1, wherein the payout for winning may include at least one of money, a credit, merchandise, and loyalty points.

16. The game according to claim 1, wherein the payout for winning money is performed by providing at least one of cash, a check, a debit card, and an account credit.

17. The game according to claim 1, wherein the payout for winning loyalty points is performed by providing at least one of a loyalty program credit and an account credit.

18. The game according to claim 1, wherein the game sessions are run continually.

19. The game according to claim 1, wherein the winning outcome is chosen in a random manner.

20. The game according to claim 1, wherein the player tells the gaming operator or computer system that the player has won.

21. The game according to claim 1, wherein the player and the winning outcome must be verified and authenticated by the gaming operator.

22. The game according to claim 21, wherein a game playing computer system displays to all players when there is a winner.

23. The game according to claim 21, wherein a game playing computer system displays to all players at least one of the winning game card and the winning player.

24. The game according to claim 1, wherein the game sessions are run continually, and wherein advertising streams are inserted into the display during the game session.

25. The game according to claim 1, wherein the game sessions are run continually, and wherein advertising streams displayed between individual game sessions.

26. The game according to claim 1, wherein the player may enter a game session through an alternative method of entry (AMOE).

27. The game according to claim 1, wherein the game and its associated game session are played using one or more computer systems.

28. The game according to claim 1, wherein the predetermined outcome is determined prior to the beginning of game play by the player.

29. The game according to claim 1, wherein the predetermined outcome is determined prior to at least one of the player paying for the game and subscribing to the game.

30. The game according to claim 1, wherein the predetermined outcome is determined after the player performs at least one of paying for the game and subscribing to the game.

31. The game according to claim 1, wherein the predetermined script is determined prior to the beginning of game play by the player.

32. The game according to claim 1, wherein the game script includes one or more elements of the game.

33. The game according to claim 32, wherein the game script includes a pay table.

34. The game according to claim 33, wherein the pay table lists possible combinations for obtaining a specific total payout amount listed in a row of the pay table.

35. The game according to claim 31, wherein the game script includes at least one of audit type, security code(s), number drawing order, prize reveal order, prize placement, game display, and total game payout.
